(19) United States
(12) Patent Application Publication
(10) Pub. No.: US 2009/0184892 A1
(43) Pub. Date: Jul. 23, 2009

(54) DISPLAY DEVICE

(75) Inventors: Martina Eberle, Zurich (CH); Christoph Niederberger, Basel (CH)

Correspondence Address: RANKIN, HILL & CLARK LLP, 38210 Glenn Avenue, WILLOUGHBY, OH, 44094-7808, US

(73) Assignee: ETH ZURICH, Zurich (CH)

(21) Appl. No.: 12/300,862

(22) PCT Filed: Apr. 24, 2007
(86) PCT No.: PCT/CH07/00196

§ 371 Date: Jan. 23, 2009

(30) Foreign Application Priority Data
May 18, 2006 (CH) 813/06

(51) Int. Cl. G09G 3/20

(52) U.S. Cl. 345/55

(57) ABSTRACT

A display device is formed from a plurality of modules (2) each including a large number of display elements (21) formed by diffusely radiating hollow bodies. The light sources thereof can be controlled individually in terms of brightness and colour. In this way, it is possible to construct large display devices for halls and stadia.

This application claims the priority of the Swiss patent application No. 0813/06, which was submitted on May 18, 2006 and the complete disclosure of which is hereby incorporated by reference.

### BACKGROUND OF THE INVENTION

The invention is related to a display device for the depiction of still or moving pictures and/or patterns, including a multitude of individual display elements arranged in the manner of points in a grid or in a grid-like manner with a spacing between one another, as well as a control device, by means of which the display elements may be activated to light-up individually or in groups. The invention is furthermore related to a method for operating a display device of this kind.

### DESCRIPTION OF RELATED ART

Display devices, by means of which still or moving pictures may be depicted, so that they are perceptible by a viewer, are known in various forms. Known in particular is a three-dimensional cubic display made out of 1000 white light-emitting diodes, which are arranged as grid points of a detached 10×10×10 matrix made of wire. Further, a three-dimensional cubic arrangement with coloured light-emitting diodes as a 3×3×3 or 4×4×4 or 8×8×8 is known for artistic purposes.

### BRIEF SUMMARY OF THE INVENTION

The invention is based on the objective of improving display devices of the above-mentioned kind.

This is achieved in that the display devices on the one hand are formed by non-transparent, light-transmitting hollow bodies, that the hollow bodies on the other hand inside contain a light source provided with a transparent housing, which in function of the control is designed for lighting-up in a multitude of colours and with a selectable brightness, and that the control device is designed for the depiction of images and/or patterns by means of the light sources. In preference, each of the hollow bodies contains two or more light sources of this kind.

It has been found that by the non-transparent, but light-transmitting hollow bodies, which in their hollow space include at least one, in preference, however, two or three light sources, which may be driven for showing a multitude of colours and which have their own light source(s) with their own respective housings, and which form display elements radiating, preferably in all directions, diffusely and in colour and which in preference are arranged as a three-dimensional grid, are suitable for providing a display device, with which for the viewer still and moving pictures and patterns, hereinafter also referred to as picture sequences, may be depicted in a better manner. The hollow bodies, in particular, provide the possibility of establishing the size of the shining display elements in function of the size of the complete display device and the spacing between the individual hollow bodies, with which only a depiction of pictures with a large viewing distance is possible, which in turn makes feasible the formation of large display devices.

Preferred is a construction, in the case of which the hollow bodies include a curved surface, particularly are spherical or cylindrical or polyhedral-shaped and in particular are cubic, cuboid or pyramidal. They include, e.g., a diameter or smaller side length of more than 2 cm and in particular more then 3 cm and in preference particularly of 3.5 up to 5 cm. The spacing of the hollow bodies between one another preferably amounts to 1.5 to 5 times their diameter or longest side and in preference amounts to 2 to 3 times, and especially approximately 2.5 times.

As a result, it is possible to make large displays, which, e.g., are suitable for viewing in stadiums or halls. In this, it is preferred that the display device is constructed in such a manner, that the display elements are fixed directly suspended from the ceiling of the room, or the display elements are fixed standing on a bottom side of the display device or directly on the floor of the room. In preference, the display device is split-up into several modules, which respectively form a unit capable of being transported and erected on its own. It is furthermore preferred—in particular in case of a version with display elements arranged hanging or standing as individual strands—that transparent supporting bracing units join together individual display elements and/or suspended parts, resp., standing parts. It is possible for the suspended parts to be designed as printed circuit boards, which then take over both the electrical as well as the mechanical joining of the display elements.

In preference, the light sources in the hollow bodies are RGB-light-emitting diodes and in particular precisely two, or more than two, light-emitting diodes per hollow body. In case of one preferred embodiment, it is possible to depict a two-dimensional, high resolution picture on a three-dimensional arrangement.

The invention is further based on the objective of creating a method for operating a display device in accordance with the invention, which enables a particularly good reproduction of pictures.

With this preferred operating method on a three-dimensional display device in accordance with the invention, it is possible to reproduce a two-dimensional, high resolution picture. In doing so, a two-dimensional picture as input signal is processed by the control circuit in such a manner, that from a certain viewing location a two-dimensional picture is reproduced by the three-dimensional arrangement, which for the viewer essentially is only identifiable from the viewing location, wherein the two-dimensional picture is reproduced in a resolution, which is greater than the resolution predefined by the arrangement of the display elements in one plane.

### BRIEF DESCRIPTION OF THE DRAWINGS

In the following, examples of embodiments of the invention are explained in more detail on the basis of the drawings. These illustrate:

FIG. 1 a schematic overview of a display device according to the invention;

FIG. 2 a depiction of a module of the display device of FIG. 1;

FIG. 3 a view of two hollow bodies;

FIG. 4 a block diagram of a control installation;

FIG. 5 a further block diagram of a part of the control installation;

FIG. 6 a further block diagram of a part of the control installation;

FIG. 7 a picture to be reproduced;

FIG. 8 its depiction on the display device;

FIG. 9 the display device viewed from a different viewing location;

FIG. 10 a schematic illustration for explaining a preferred type of depiction;

FIG. 11 a further illustration of the preferred type of depiction.

### DETAILED DESCRIPTION OF THE INVENTION

FIG. 1, in a very schematic overview, depicts the fundamental construction of a preferred embodiment of the display device 1. It comprises a large number of modules 2, each of which comprises a multitude of display elements, as will be explained in more detail. A module of this type is illustrated in more detail in the lower left-hand corner; the further modules are only indicated by the sub-division of the upper side of the display device in FIG. 1. It is possible for every module 2 to have dimensions on its upper side of 0.5 m×0.5 m. A module of this kind in this embodiment may comprise 250 display elements constructed as hollow bodies. In case of the device depicted as an example, longitudinally 20 modules of this kind are arranged, so that the complete display device comprises a length of 10 m, and transversely 6 modules are provided, which results in a width of 3 m. The hollow bodies, in preference, are arranged as suspended from the upper side of every module and extending approx. 1 m downwards from the upper side, so that the display device 1 comprises a height of 1 m. In case of this display device depicted as an example, therefore it is possible that 30,000 display elements constructed as hollow bodies are present, which are arranged in the form of grid points regularly arranged within the mentioned volume of 10 m×3 m×1 m. These dimensions, of course, are only to be understood as an example and it is possible that the display device is larger or smaller and that the number of display elements is different. It would also be possible to implement a display device of this kind as only a two-dimensional display device, in the case of which, e.g., therefore only the front layer of the display elements would be present. It is possible that the hollow bodies in this case would be arranged, e.g., in front of a wall. In the following, however, the display device is explained on the basis of a three-dimensional construction, which is preferred. A two-dimensional construction, however, is jointly comprised.

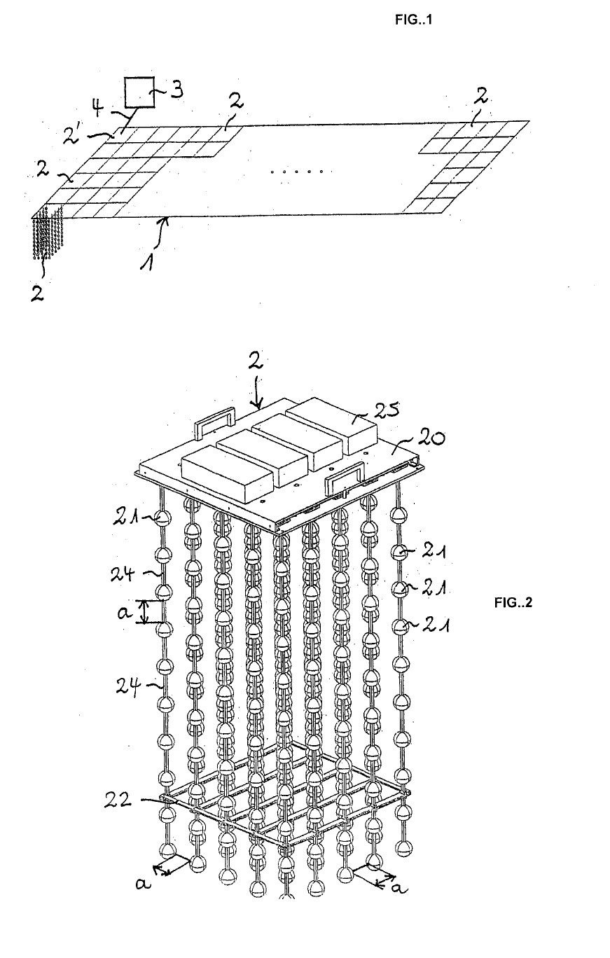

In preference, all modules 2 except for one module are implemented identically, which simplifies the construction of a display device of this kind. A single module, in the Figure, the one in the left-hand rear corner of the module 2′ depicted with the sub-division only, forms the connection for that part of the control device, which is not located at the modules 2, but rather is arranged centrally and forms an operating possibility for the display device 1. This part of the control installation may be formed by one or several control computers 3, which are connected with the input module, e.g., by an Ethernet bus connection. The further connection thereafter is effected from module to module, so that the depicted simple structure results. This, however, is only to be understood as an example. It would also be possible, that the control computer 3 is separately connected with every module, be this by a wire connection or also by a wireless connection. Furthermore, it is also possible, that the control computer 3 is arranged on one of the modules and that therefore the connection 4 is omitted. The Ethernet connection is effected in a familiar manner by the Media Access Control (MAC) protocol. FIG. 2 as an example now illustrates a module 2, which comprises an upper carrier arrangement 20, suspended from which the display elements 21 are arranged, which in this example are implemented as spherical hollow bodies. This is to be understood as a preferred example, and enables the simple connecting of the individual modules and with this of the complete display device to the ceiling of a room, e.g. of a hall or of a stadium. It is, however, also possible to implement the display device with display elements 21 extending upwards from a base plate. Instead of the sequence of display elements 21 extending downwards in strands, then an extending upwards results, wherein the display elements 21, e.g., are arranged on rod-shaped carriers. Furthermore possible is a lateral extending from a carrier or from a wall. The carrier arrangement 20, in preference, comprises the elements required for controlling the respective display elements 21, e.g. data multiplexers and at least one electric power supply and also interfaces to the further modules.

FIG. 2 also illustrates the preferred arrangement, in the case of which the individual display elements 21 are arranged regularly along a multitude of suspended strands. In the example depicted, every strand comprises 10 display elements 21. The respective module comprises, e.g., 5×5 strands and therefore in total 250 display elements 21. In every strand the electric power supply for the light sources of the display elements 21, starting out from the carrier arrangement, is conducted downwards up to the last display element, equally the control signals for the individual display elements are conducted along the strand, which will be explained in more detail. The strands are freely suspended, in preference, however, at least one supporting bracing unit, as is illustrated in FIG. 2 with the supporting bracing unit 22. This, in preference, works at the strand connections 24 between the display elements 21 and it is preferably a transparent supporting bracing unit 22, e.g., made of plastic material, which disrupts the viewing of the display elements of the display device as little as possible.

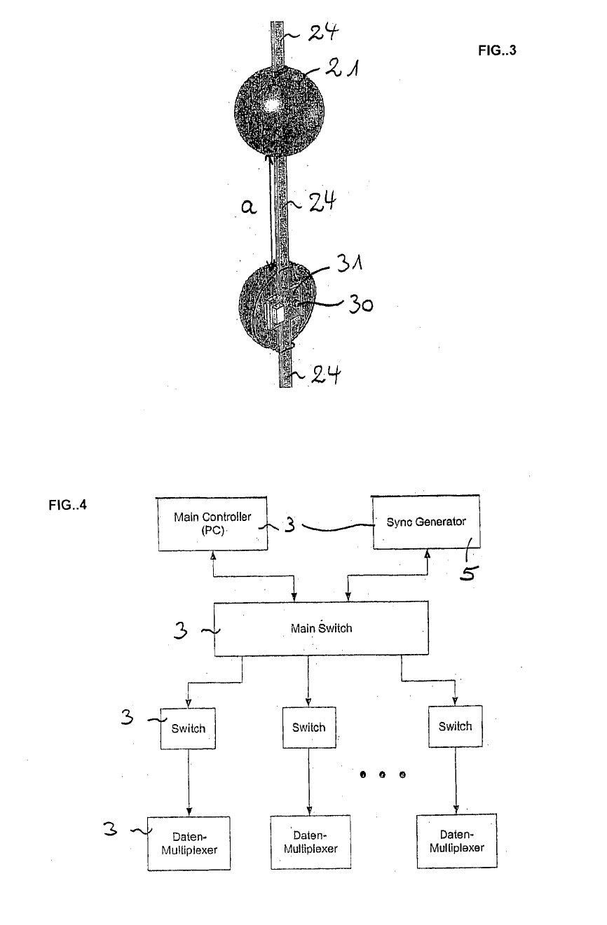

FIG. 3 illustrates a preferred embodiment of the display elements 21. These in accordance with the invention on the one hand comprise non-transparent, but light-transmitting hollow bodies. In case of the example of FIG. 3, the hollow body is spherical. Other hollow body shapes, such as, e.g., cylinders or polyhedrons, such as, e.g., cubes or cuboids or pyramids are also possible. The non-transparency of the respective hollow body, which in preference, is made out of plastic material, may be the result of a coating of a transparent hollow body on its external side and/or its internal side. It is also possible that it results from a mixing of light scattering material with the transparent plastic material or by the processing of the plastic material surface of the inside and/or of the outside of the hollow body, which causes a strong light scattering. By means of these or other measures known to the specialist an effect results, as is known from cloudy glass, in particular frosted glass, in the case of which while light penetrates to the outside from the light source inside the hollow body, so that the hollow body is perceived as an essentially uniformly diffusely radiating body, in the case of which, however, the light source is not visible as a point light source inside the hollow body. As a light source, which is preferably centrally arranged inside the hollow body, at least one light-emitting element equipped with a light-transmitting housing, preferably at least one light-emitting diode 30 is provided. In preference, at least two light-emitting diodes are provided and in particular precisely two light-emitting diodes 30, which each respectively are arranged on both sides of a board 31, in order to result in an as uniform as possible lighting of the hollow body. The light sources are constructed in such a manner, that they may be controlled by the control device both with respect to their brightness as well as to their colour. In doing so, utilised as light-emitting diodes are so-called RGB light-emitting diodes, which may simultaneously produce the colours red, green and blue, so that by mixing the colours any colour can be produced. For controlling them any circuits known to the specialists may be utilised. In case of all embodiments of the invention, it is possible to utilise other light sources instead of the mentioned light-emitting diodes, thus in particular also organic light-emitting diodes (OLED).

In preference also, the strands 24 are formed by printed circuit boards, which are provided with conductors for the electric power supply of the light sources and with signal conductors for controlling them. In the area of every hollow space of the hollow bodies, then in preference, the printed circuit board 24 is enlarged to form the board 31 in order to accommodate the components for the operation and controlling of the light source 30. The hollow bodies 21, preferably, are constructed of half shells, as is evident from FIG. 3. At the respective fixing point of the hollow body shells on the strand 24 any fixing—and/or securing means may be provided and in preference the hollow bodies on the strand 24 are sealed against the ingress of water, which makes possible the utilisation of the display device also outdoors and also to clean them with water. As material for the hollow bodies, in particular a plastic material is utilisable, as already mentioned, and in preference a construction out of polycarbonate (macrolon, Lexan®) and, e.g., a construction, in the case of which the hollow body is 98.5% transparent and 1.5% coloured white, which results in the mentioned desired effects of non-transparency together with a simultaneous high light transmission capacity.

The spacing between individual display elements 21 of the display device 1, in preference, is identical within the individual strand as well as laterally from strand to strand. It is also possible, however, that this spacing is selected to be differing. FIG. 3 and FIG. 2 depict a spacing “a” within every strand 24 as well as the same spacing “a” between the strands. In preference the size of the spacing “a” is approx. 1.5 times the diameter “b” of a hollow body up to approx. 5 times the diameter “b” of a hollow body. In particular the spacing “a” amounts to 2 times and especially approx. 2.5 times the diameter of the hollow body. If the hollow body is not spherical or cylindrical, then instead of the diameter one departs from the greatest side length of the body. The diameter of the body 21 in preference is situated in the range of 2 cm to 6 cm. Preferred is, e.g., a diameter of 4 cm and a spacing “a” of 10 cm.

The interface of the control installation, which connects the control computer 3 of the control installation with the first module, in preference is a fast Ethernet interface. The data volume may comprise, e.g., 4 bytes of data per light source, resp., per hollow body, a further 4 bytes of control information, which for the, for example, 10 display elements 21 of every strand results in 44 bytes. If one departs from an operation with 20 Hz, there results 880 bytes per strand per second. For the 25 strands of each module, therefore, a value of 22 Kbytes per second per module and for the 120 modules of the display device illustrated as an example a data volume of 2.64 Mbytes per second. It is easily possible to transmit a data volume of this magnitude with a fast Ethernet interface between the computer 3 and the input module. The transmission may take place by means of conventional IP (UPP) protocols. The data multiplexers on the modules are all provided with a fast Ethernet interface and combined with several switches and connected with the control computer 3.

FIG. 4 depicts a block diagram of an arrangement of this kind. The fast Ethernet connections are all point-to-point connections. It is therefore possible to connect the data multiplexers on the modules (in case of this example 120 pieces) with the computer 3 with switches. A main switch is utilised on the computer side, which copes with the greatest data throughput. In preference, a synchronisation generator 5 separate from the computer 3 is utilised, which e.g., transmits a synchronisation signal every 25 milliseconds. This is signal utilised in order to trigger the temporally precise display of picture data on the 24 strands in the individual hollow bodies 21. In this manner, the pictures produced by the display device 1 may displayed simultaneously very precisely, without making any high real-time demands of the computer 3. The individual modules and the individual strands and in them the individual display elements 21 are provided with addresses and the computer 3 transmits the data with the corresponding addresses, so that the picture to be displayed may be produced by the activation of the respective display elements 21. The individual light sources, resp., light-emitting diodes, in preference are driven with a constant current driver. Preferred is a 10 bit resolution per colour, which corresponds to a colour depth of 30 bit (one billion colours).

FIG. 5 illustrates the block circuit diagram of a data multiplexer of the kind wherein it is possible to utilise in case of the modules. The data multiplexers receive the data through the fast Ethernet interface and distribute it to the 25 strands 24, which are assigned to them. A data multiplexer essentially comprises a 100BaseT MAC and an FPGA, which buffers the data and splits it up over the LED strands. The strands are respectively connected with the FPGA through a serial interface. In preference, the data multiplexer simultaneously is cabling of the 25 strands. The data lines to the individual strands are conducted as differential (RS422/RS485) signals. In doing so, every module is functionally and electrically separated from the other modules.

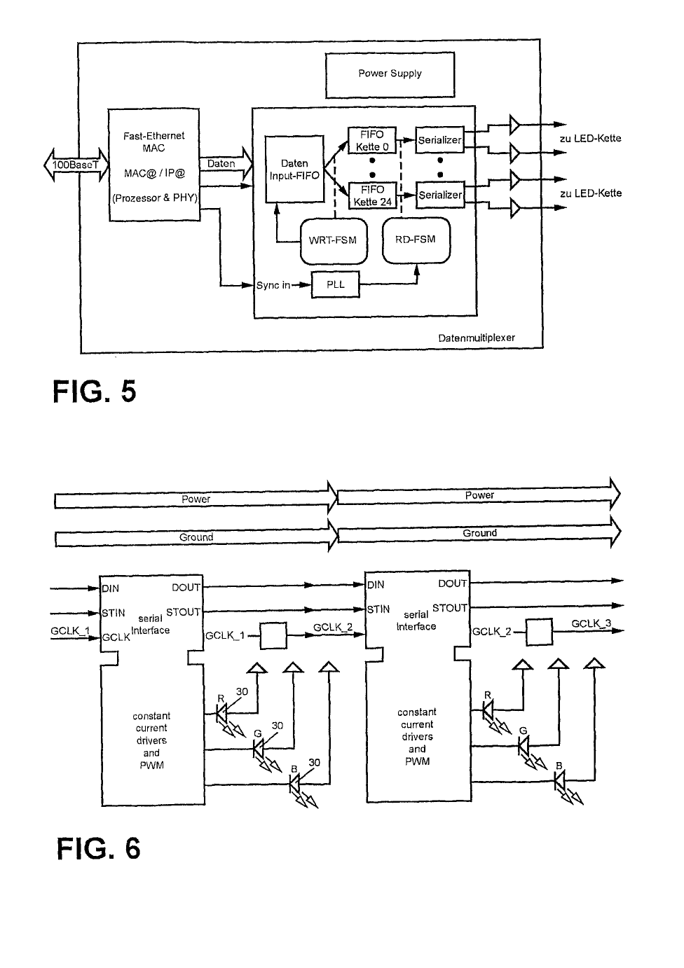

FIG. 6 furthermore depicts the electrical structure of the light source in every display element 21, for which purpose in the hollow bodies corresponding constant current drivers are provided, which have a built-in serial interface. It is therefore possible for the display elements 21 to be connected together in a daisy-chain configuration with two signals and a clock. The clock signal preferably is newly prepared at every hollow body, so that it is only point-to-point connections, which respectively have to bridge the spacing “a”.

The pictures or patterns to be displayed on the display device may be calculated and stored in advance, whereupon the pictures or patterns, resp., picture sequences are read from the storage medium by the control computer and transmitted to the individual display elements. In another preferred embodiment, however, the picture sequences are produced directly in real time from input data or input signals. Thus it is possible, for example, to convert by a microphone acoustic events into electric input signals for the control computer, which then converts these acoustic events into picture sequences in the form of patterns and/or pictures and correspondingly drives the display elements, or else picture input data from a camera may be directly input to the drive of the display elements.

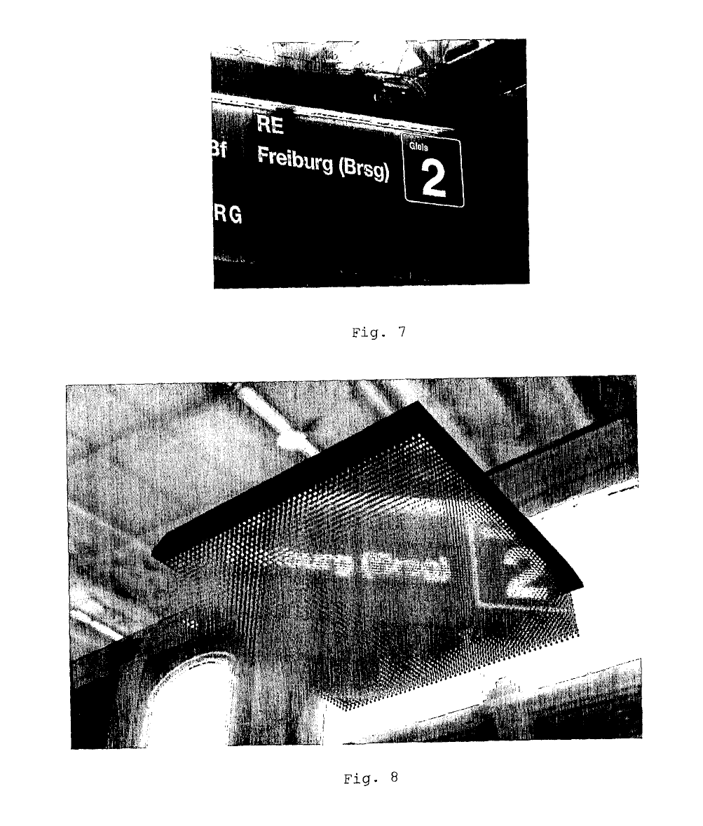

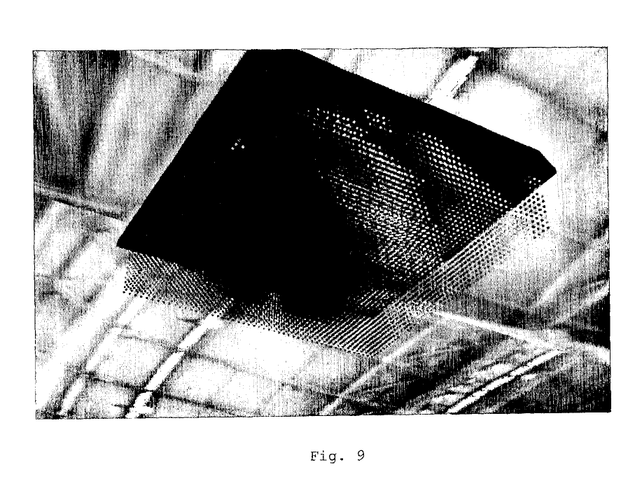

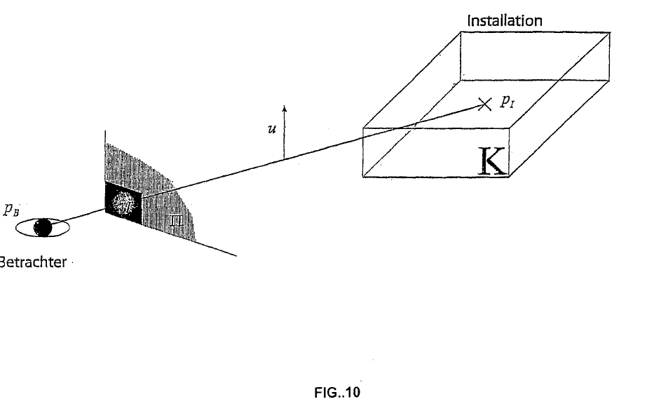

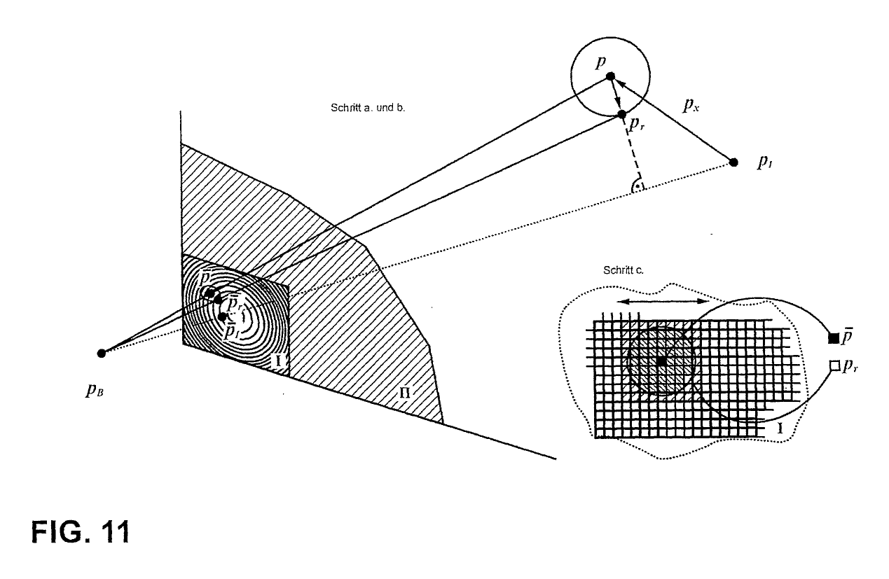

It is possible for the display of pictures on the display device to take place in such a manner, that pictures are produced on the individual planes of the display elements, which together result in a standing and/or moving picture or pattern, which is perceptible from different viewing locations. The corresponding control of the display elements 21 may easily be implemented by the skilled person and is not explained in more detail here. In case of one preferred embodiment, however, the control installation is constructed in such a manner, resp., the operation of the display device takes place in such a manner, that it calculates the projection of two-dimensional input data into the display device, that the image of the input data is only perceivable from a certain location (hot-spot). This takes place with a significantly higher resolution than in the case of the approach mentioned, which places the data in axis-parallel planes. The FIGS. 7, 8 and 9 on the one hand in FIG. 7 illustrate a two-dimensional picture, which—as is explained in detail in the following—is prepared with the control device, resp., in accordance with the preferred operating procedure and displayed on the display device, so that from one viewing location, from which one of the lateral surfaces is not looked at, the relatively high resolution picture of FIG. 8 results. FIG. 9 depicts the display device with the picture from a different viewing location, from which the picture is not discernible. It the following it is explained, how the display device is driven by means of the control installation, in order to obtain this depiction of a two-dimensional picture in the three-dimensional display device. In doing so, reference is made to the FIGS. 10 and 11.

The algorithm is a function F(p₁,p_{B},K,u,I), wherein in accordance with FIG. 10
p₁ is the predefined 3D-position of the installation, usually the centre,
p_{B} is the freely selectable 3D-position of the eyes of the viewer,
K is there configuration of the installation, wherein K comprises the 3D-positions pₓ of the luminous elements relative to p₁ as well as their diameter d. K is fully predefined in advance for any installation. The spacing between the luminous elements is implicitly given in pₓ.
u is the so-called up-vector, which defines the rotation of the projection around the centred viewing beam. This is usually a vertical vector of any length.
I is a two-dimensional input signal. Usually this is a digital image or a video, also, however, a continuously defined function is possible. In the latter case I also comprises a grid value R₁.

The algorithm now processes the following steps one after the other:

### 1. Initialisation of the 4×4 Projection Matrix P:

The projection matrix is defined by p₁, p_{B} and u and may be calculated by means of the freely available method in the glut library gluLookAt (p_{B},p₁−p_{B},u). P now describes the image (projection) of a three-dimensional dot x—e.g., the position of a luminous element of the installation—into the two-dimensional coordinate system of a virtual input plane Π (into which the input I comes to lie), which is located vertically on the connection between p₁ and p_{B}. p̅₁̅=P·p₁ is the projected position of the installation.

2. Thereafter for all luminous bodies pₓpₓεK.
a. The position vector p=p₁+pₓ is multiplied with the projection matrix:
   p̅=P·p, wherein p̅ now describes the projected position of the luminous element on the input plane. Because in the case of p̅ it is a three-dimensional vector, in order to obtain the effective 2D image coordinates it still has to be projected onto the z=1 plane:
   p̅= p̅ₓ̅/ p̅_̅{̅z̅}̅, p̅_̅{̅y̅}̅= p̅/ p̅_̅{̅z̅}̅ and p_{z}=1. With this p̅) has the form

$$\overline{p} = [ \begin{matrix}x \\ y \\ 1\end{matrix} ] ,$$

wherein x and y describe the position of the projection in the 2D input plane Π.
b. In order to know the extent of the luminous element in the image plane, the radius of the spherical projection has to be calculated:
   Added to p₁+pₓ is a vector r standing orthogonally on the beam p_{B}p₁, which has the length of the radius of the luminous body d/2:

$$i . {r}^{′} = ( {p}_{I} - {p}_{B} ) \times [ \begin{matrix}0 \\ 0 \\ 1\end{matrix} ]$$

stands vertically on p_{B}p₁

$$ii . r = \frac{d}{2} \cdot \frac{{r}^{′}}{‖ {r}^{′} ‖}$$

is the vector r standardised to d/2, wherein
d is the diameter of the luminous body and ∥r′∥ the length of r′.
iii. Now by means of p̅ᵣ̅=P·(p₁+pₓ+r) in analogy to step a the projection of the edge point
p̅ᵣ̅=p₁+pₓ+rpr into the input image plane may be calculated.
iv. The projected radius R now results by means of

R=∥ p̅− p̅ᵣ∥
c. The colour of the current luminous body now results from the averaged colour values of all input data p̅₁̅, for which R≧∥ p̅− p̅₁̅∥ is applicable. S=0, c=0 is set. In this, the selection of the to be tested p̅₁̅ depends on the input I:
   i. In the case of a rastered input I=f(x,y),xεN,yεN for example, digital images, videos, for p̅₁̅ the predefined pixels are utilised. With this, R_{I}=1 results and the execution as in case ii).
   ii. In the case of an input of the form I=f(x,y),xεR,yεR, thus continuously defined functions, this still remains to be rastered. The user-defined parameter R_{I} in this defines the step width, with which are produced. Now the values

$$f ( {\overline{p}}_{Test} \cdot x , {\overline{p}}_{Test} \cdot y ) , {\overline{p}}_{Test} = \overline{p} + k \cdot [ \begin{matrix}{R}_{I} \\ 0 \\ 0\end{matrix} ] + l \cdot [ \begin{matrix}0 \\ {R}_{I} \\ 0\end{matrix} ]$$

k=R/R_{I} . . . R/R_{I}, l=−R/R_{I} . . . R/R_{I} tested to the distance ∥ p̅− p̅_{Test}∥ and compared with R. Only when the distance ∥ p̅− p̅_{Test}∥ is smaller than or equal to R, the value S=S+f( p̅_{Test}x, p̅_{Test}·y) is added up and c=c+1.
d. The colour value of pₓεK now results from S/c.
   3. Consequently all luminous bodies pₓεK have a colour value, which corresponds to the input data from/covered by the projected sphere.

While in the application presented here preferred embodiments of the invention are described, it has to be clearly pointed out, that the invention is not limited to these and that it is may also be implemented in a different manner within the scope of the following claims.

1. Display device (1) for showing still and/or moving pictures and/or patterns, comprising
a plurality of individual display elements (21) arranged in the manner of grid points of a grid or in a grid-like manner, as well as
a control installation (3, 4), by means of which the display elements are activatable to light up individually or in groups,
wherein the display elements comprise non-transparent, light-transmitting hollow bodies, in which there is/are, at least one light source equipped with a light-transmitting housing and at least one luminiferous element (30), which in function of the control is constructed to light-up in one of a multitude of colours and with a selectable brightness, and that the control installation is designed for showing pictures and/or patterns by means of the light sources.

2. Display device in accordance with claim 1, wherein the display elements are arranged in the manner of grid points of a three-dimensional grid or three-dimensionally grid-like.

3. Display device in accordance with claim 1, wherein the display elements are arranged in the manner of grid points of a two-dimensional grid or two-dimensionally grid-like.

4. Display device in accordance with claim 1, wherein the hollow bodies comprise at least one curved surface and are spheres or cylinders.

5. Display device in accordance with claim 1, wherein the hollow bodies are cubes or cuboids or pyramids.

6. Display device in accordance with claim 1, wherein the hollow bodies are made of transparent plastic material and are made non-transparent by a coating and/or adding a material to the plastic material and or by a processing of the internal—and or external walls of the hollow body.

7. Display device in accordance with claim 1, wherein the distance of the external walls of the hollow bodies from one another amounts to 1.5 times up to 5 times the diameter or the longest side length of the hollow body.

8. Display device in accordance with claim 1, wherein the hollow bodies comprise a diameter or a shortest side length of more than 2 cm.

9. Display device in accordance with claim 1, wherein the hollow bodies are arranged hanging or standing as individual strands (24) of several hollow bodies connected together, which strands in particular are fixed to a carrier element (20).

10. Display device in accordance with claim 9, wherein the carrier element carries the control installation or a part of it.

11. Display device in accordance with claim 9, wherein several individual strands are connected together by supporting bracing units (22), in particular transparent supporting bracing units.

12. Display device in accordance with claim 1, wherein the device is constructed out of a multitude of identical modules (2), which modules respectively comprise a number of hollow bodies (21) and a part of the control installation.

13. Display device in accordance with claim 9, wherein the carrier elements are designed to be fixed to the ceiling of a room.

14. Display device in accordance with claim 1, wherein the light sources are formed by RGB light-emitting diodes (30).

15. Display device in accordance with claim 9, wherein the electric power supply and the signal transmission to the light sources takes place through the strands (24).

16. Display device in accordance with claim 1, wherein the control installation comprises one or several control computers (3) and a synchronisation arrangement (5) separate from these.

17. Display device in accordance with claim 16, wherein the control computer or the control computers is/are capable of transmitting a picture sequence to the individual hollow bodies.

18. Display device in accordance with claim 17, wherein a picture sequence is reproducible synchronised by all hollow bodies.

19. Display device in accordance with claim 16, wherein the picture sequence is calculatable in advance and storable in memory and that the picture sequence is readable by the control computer or control computers and transmittable to the individual luminous elements, or that the picture sequences producible in real time from input data and are transmittable to the individual hollow bodies.

20. Display device in accordance with claim 16, wherein the control computer is capable of calculating the picture sequence.

21. Display device in accordance with claim 1, wherein the control installation is capable of processing the picture in such a manner by, that viewed from a certain viewing location a high-resolution two-dimensional picture may be reproduced.

22. Method for operating a display device in accordance with claim 2, wherein a two-dimensional signal as input signal is processed by the control circuit in such a manner, that from a certain viewing location a two-dimensional picture is produced by the three-dimensional arrangement of hollow bodies, which for the viewer in essence is only perceivable from the viewing location, wherein the two-dimensional picture is reproduced in a resolution, which is higher than the resolution predefined by the arrangement of the display elements in one plane of the display device.
